(19) United States
(12) Patent Application Publication
(10) Pub. No.: US 2025/0344730 A1
(43) Pub. Date: Nov. 13, 2025

(54) LOW SUGAR-BASED FOOD COMPOSITIONS WITH ROASTED INGREDIENT

(71) Applicant: SOCIETE DES PRODUITS NESTLE S.A., Vevey (CH)

(72) Inventors: ONDREJ NOVOTNY, Cugy (CH); SANDRA GALLE, Orbe (CH); EMILIE LABAT, Renens (CH); BALTASAR VALLES-PAMIES, Prilly (CH)

(21) Appl. No.: 18/722,325

(22) PCT Filed: Dec. 21, 2022
(86) PCT No.: PCT/EP2022/087303

§ 371 Date: Jun. 20, 2024

(30) Foreign Application Priority Data
Dec. 22, 2021 (EP) 21216853.8

(51) Int. Cl. A23L 19/18; A23L 7/126; A23L 29/00

(52) U.S. Cl. CPC A23L 19/18; A23L 7/126; A23L 29/035; A23L 29/045

(57) ABSTRACT

The present invention relates to a low sugar food composition with organoleptic properties for infants and young children comprising a plant-based roasted ingredient. The said food composition has low level of process contaminants and possess desired colour and aroma markers thus imparting desired organoleptic properties. The methods for preparing such compositions are disclosed too.

### CROSS REFERENCE TO RELATED APPLICATIONS

The present application is a National Stage of International Application No. PCT/EP2022/087303, filed on Dec. 21, 2022, which claims priority to European Patent Application No. 21216853.8, filed on Dec. 22, 2021, the entire contents of which are being incorporated herein by reference.

### FIELD OF THE INVENTION

The present invention relates to low sugar-based food composition comprising roasted plant-based ingredients selected to generate improved organoleptic properties (colour and flavour), which are preferred by consumers. The said food composition is suitable for infants and young children.

### BACKGROUND

Proper nutrition during infancy and early childhood is fundamental to the development of a healthy adult. Cereal-based foods are an important source of energy, carbohydrates, protein, vitamins, and minerals for infants from 6 to nearly 36 months old.

Processed cereal-based food products with no added nor produced sugars are gaining a significant attention from both health authorities and the consumers. For example, in 2015, the WHO recommended that free sugars should contribute to less than 10% of total daily energy intake. Pale colour and a blander flavour make those low-sugar products often less attractive for the consumers than the original products with higher sugar content.

In general, the flavours of a food product come from intrinsic flavours of ingredients, flavours generated during the processing and eventually flavouring addition (top notes), if used in a product. In processed low-sugar cereal-based products, the drawback of each flavour source is described as follows:
Intrinsic flavours of ingredients used for the manufacturing are usually not appealing enough. Lack of sugars in the product reduces sweetness, which is one of the key sensory drivers of consumer preference.
Flavours generated during the ‘standard’ processing of cereal products (roller-drying, extrusion, baking, etc.) are limited due to lack of their precursors (sugars) provided by the low sugar product brief (product without hydrolysed cereals nor added sugars).
Moreover, in case of roller-drying of low sugar cereal product, mild drying conditions must be used to ensure good film formation and throughput. Those mild conditions further limit flavour generation during this process.
Use of commercial flavourings in infant nutrition products is intricate since they are either not allowed by some local regulations or not well perceived by the consumers

Roasting is known to create flavours and roasted grain ingredients such as rye, barley, wheat, rice, and others are incorporated in various processed foods such as bakery and confectionery.

Key prerequisites for flavour and colour generation during manufacturing of cereal-based food product are presence of sugars and appropriate thermal conditions.

Presence of high sugar amounts in products intended for nutrition of infants and young children is however not desired from nutritional reasons.

Regarding manufacturing, a common approach to the improvement of organoleptic properties (colour and flavour) of cereal based food products is to increase residence time during cooking and/or the temperature of heat treatment, yet an increase in residence time reduces the throughput that is a significant drawback for factory production. More extensive heating also has a negative impact on a nutritional value (e.g. lysine blockage), on food safety (e.g. generation of process contaminants) and can result in modification of the texture. Moreover, roller-drying of low sugar cereal products has certain limitations and allows to use only mild thermal conditions that are often not sufficient for satisfactory colour and flavour generation.

EP1908356 relates to methods for producing roasted grain extracts in which extracts containing roasted components are produced from roasted grain and methods for producing processed roasted grain products obtained by processing roasted grain.

RU2471558 relates to the automation of technological processes and can be used for the automation of the process of the hydrothermal working of grain of oats with the production of oat-flour.

JP2011177109 relates to a roasted cereal extract and a method for producing the same. The present invention also relates to a beverage comprising a roasted cereal extract.

EP0453390 refers to a process for the preparation of foodstuffs in which the main component is cereals, as well as the food products obtained by this process, which as a result have better organoleptic (flavour/aroma) and hygienic properties, improved dispersibility, durable viscosity and a smaller amount of cariogenic edulcorants.

The present invention is based on low sugar composition wherein hydrolysis may not be required or avoided.

Thus, there is a need to deliver and/or enhance preferred consumer notes (for example biscuit, toasty, roasty and/or caramel notes) in cereal-based products without the need to add to the recipe ingredients which are not natural or are artificial. There is also a need to have cereal-based food products enhanced in preferred consumer flavour notes and having an appropriate visual appearance in terms of colour without compromising on nutritional superiority and keeping low sugar amount.

### SUMMARY OF THE INVENTION

In one aspect, the present invention relates to roasting of plant-based ingredients such as cereal grains, leguminous seeds or beans to generate unique flavour profiles and use of roasted ingredients for production of a cereal-based compositions as a baby food product. The improvement of organoleptic properties is achieved by ‘100% Natural’ and ‘clean label’ approach. The invention is specifically related to low-sugar Infant Cereal products without hydrolysed cereals nor added sugars.

In one aspect, the present invention relates to a low sugar food composition with organoleptic properties for infants and young children comprising a plant-based roasted ingredient, wherein the total sugars in the composition is less than 5 g/100 g; wherein said composition has a* colour space parameter comprising a a*value above 0; and wherein the roasted ingredient is obtainable by roasting to an extent that when said roasted ingredient is added to the food composition, the said food composition comprises sum of pyrazines containing 2-ethyl-6-methylpyrazine, 2-ethyl-5-methylpyrazine, 2,3,5-trimethylpyrazine, 2-ethyl-3-methylpyrazine, 2-ethyl-3,6-dimethylpyrazine and 2-ethyl-3,5-dimethylpyrazine in amount greater than 20 parts per billion (ppb). The total amount of sugars refers to mono-(glucose, fructose and galactose) and di-saccharides (sucrose, lactose and maltose) except naturally occurring lactose from dairy ingredients.

In one aspect, the present invention relates to a method of preparing a composition with organoleptic properties comprising a plant-based roasted ingredient, wherein the total sugars in the composition is less than 5 g/100 g comprising: (a) providing the plant-based ingredient (b) roasting of the said plant-based ingredient at temperature from 120° C. to 220° C. for time between 1 min to 600 min; (c) grinding of said roasted ingredient to obtain a flour; (d) incorporation of said flour into cereal-based composition at dosage between 1% to 50% w/w; and (e) subjecting to any of following processes comprising roller-drying, extrusion, baking and/or spray-drying to obtain a finished product. The finished product obtainable from said method comprises low amounts of process contaminants in particular furan in amount below 50 ppb; acrylamide in amount below 60 ppb. The finished product obtainable from said method comprises total amount of Strecker aldehydes containing 3-methylbutanal, 2-methylbutanal, methional and phenylacetaldehyde greater than 150 ppb. The finished product obtainable from said method comprises amount of 4-hydroxy-2,5-dimethyl-3 (2H)-furanone (HDMF) greater than 200 ppb.

In one embodiment of the present invention, in the method of preparing a composition with organoleptic properties comprising a plant-based roasted ingredient, the roasting is performed at a temperature ranging from 140° C. to 220° C. for time between 1 min to 600 min. In one aspect the present invention relates to use of the composition prepared by above method for manufacture of food for infants and young children.

### BRIEF DESCRIPTION OF THE DRAWINGS

FIG. 1 Impact of native and roasted white quinoa, red quinoa, wheat and soy on colour space parameter a* in processed multicereal-based food product (P1). The impact of ingredient was assessed at dosage of 5%.

FIG. 2 Impact of recipe of processed cereal-based food product on colour space value a* measured in powders and corresponding paps.

### DETAILED DESCRIPTION OF THE INVENTION

### Definitions of Terms

The term “low-sugar food composition” or “low sugar baby food composition” or “low sugar” in the context of the present invention relates to total sugars in the final powdered composition to be less than 5 g/100 g of the final composition, while naturally occurring lactose from dairy ingredients is not counted in this sum of total sugars. In one embodiment of the present invention, total sugars in the final powdered composition are less than 2.5 g/100 g of the final composition. In a further embodiment of the present invention, total sugars in the final powdered composition are less than 2 g/100 g of the final composition, for example less than 2 g/100 g of the final composition.

The sum of total sugars in the context of the present invention refers to mono-(glucose, fructose and galactose) and di-saccharides (sucrose, lactose and maltose). Only added pure lactose is counted in this sum, while lactose naturally occurring in dairy ingredients is not counted in the sum of total sugars.

The term “total sugars” refers to the following:
All mono-(glucose, fructose and galactose) and di-saccharides (sucrose, lactose and maltose), and other isolated sugar preparations such as food components used as such or added during food preparation and manufacturing.
Sugars from maltodextrins.
Mono- and disaccharides produced through hydrolysis process such as hydrolysis of cereals or other starch sources or from hydrolysis of lactose from dairy ingredients,
Sugars present in caramel, honey, syrups, malt extract or any ingredients derived from fruit and vegetable such as “powder”, “puree”, “juice” or “concentrate”.

The term “cereal-based composition” refers to food for infants and young children. According to the Codex STAN 074-1981 and EU Directive 2006/125/EC: “Complete infant cereals” are defined as “cereals with an added high protein food which are or have to be prepared for consumption with water or other appropriate protein-free liquid”. As opposed to “standard infant cereals” “which are or have to be prepared for consumption with milk or other appropriate nutritious liquids”.

TABLE 1
Definition of two groups of processed cereal-based product for infants
and young children along with their reconstitution into a pap

| | Standard products | Complete products |
|---|---|---|
| Codex and EU definition | Products which are or have to | Products with an added high |
| | be reconstituted for the | protein food which are or |
| | consumption with milk or | have to be reconstituted for |
| | other appropriate nutritious | consumption with water or |
| | liquids. | other appropriate protein- |
| | | free liquid. |
| Recommended reconstitution of | 25 g powder/160 mL milk | 50 g powder/150 mL |
| products with added or produced | | water |
| sugars (sugars >10 g/100 g) | | |
| Recommended reconstitution of | 18 g powder/160 mL milk | 40 g powder/150 mL |
| products with no added nor | | water |
| produced sugars* | | |
| (sugars <5 g/100 g) | | |

*viscosity of such paps is higher, compared to products with added or produced sugars, therefore amount of powder taken for reconstitution must be reduced to achieve desirable viscosity

In an embodiment of the present invention the finished product may be based on complete or standard product as described above. In an embodiment the finished product is a powder or a pap (reconstituted as defined above).

The term “process contaminants” refers to substances such as furan and acrylamide that are formed in food or in food ingredients when they undergo chemical changes during the processing. Roasting as a high temperature process represents a risk for the formation of two process contaminants: acrylamide and furan. The roasting parameters must therefore be optimized to minimize generation of the contaminants, while ensuring formation of desirable colour and flavour. In an embodiment of the present invention, the amount of furan in the final composition is less than 50 parts-per-billion (ppb). In an embodiment of the present invention, the amount of acrylamide in the final powdered composition is less than 60 ppb.

In one embodiment the low sugar food composition is a powder or pap. The pap is prepared, for instance as shown in Table 1. In one embodiment the amount of furan in the low sugar food composition is below 50 ppb. In another embodiment the amount of acrylamide in the low sugar food composition is below 60 ppb.

The term “aroma” or “smell” refers to a chemical sense stimulated by the chemical properties of odour molecules that humans and animals can perceive by their sense of smell. Smells are detected by breathing air that carries odour molecules. Therefore, to smell, molecules must be airborne (i.e. volatile).

The term “taste” refers to a chemical sense stimulated by the chemical properties of taste molecules that humans and animals can perceive by their sense of taste. Taste perception is produced or stimulated when a substance in the mouth reacts chemically with taste receptor cells located on taste buds in the oral cavity, mostly on the tongue.

The term “flavour” refers to a food feature determined by aroma and taste of food.

The term “sensory perception of food” refers to the perception triggered during food consumption by senses for aroma and taste along with trigeminal nerve stimulation registering texture, pain, and temperature. In an embodiment, the final composition of the present invention may be characterized with flavour attributes such as toasty, roasty, baked, caramel, biscuity, cookie, pop-corn, malty, smoky.

“Plain low-sugar cereal-based products” are products without flavouring or ingredient with strong flavouring properties (e.g. fruit or vegetable powder, cocoa powder, etc.). Those products typically have flavour characterized as bland, cereal, whole grain, and milky with lack of sweetness. Such flavour is less preferred by majority of the consumers worldwide.

The term “Strecker aldehydes” refers to group of odour-active compounds that are formed by Strecker degradation that converts an α-amino acid into an aldehyde.

The term “Strecker aldehydes” in the context of the present invention relates to sum of concentrations of aroma compounds from group of Strecker aldehydes in powdered product. Group of Strecker aldehydes contains following four aroma compounds: 3-methylbutanal, 2-methylbutanal, methional, phenylacetaldehyde. In an embodiment of the present invention, the sum of Strecker aldehydes in the final composition is greater than 150 ppb.

The term “pyrazines” in the context of the present invention relates to alkylpyrazines that are chemical compounds based on pyrazine, heterocyclic aromatic organic compound, with different substitution patterns.

The term “pyrazines” refer to sum of concentrations of aroma compounds from group of alkylpyrazines in powdered product. Group of pyrazines contains following six aroma compounds: 2-ethyl-6-methylpyrazine, 2-ethyl-5-methylpyrazine, 2,3,5-trimethylpyrazine, 2-ethyl-3-methylpyrazine, 2-ethyl-3,6-dimethylpyrazine, 2-ethyl-3,5-dimethylpyrazine. In an embodiment of the present invention, the sum of said pyrazines in the final composition is greater than 20 ppb.

The term “4-hydroxy-2,5-dimethyl-3 (2H)-furanone” abbreviated as “HDMF” refers to an aroma compound present naturally in variety of plant-based materials (e.g. strawberry, pineapple, buckwheat, tomato) or generated from sugars during thermal processing of food. In an embodiment of the present invention, the concentration of 4-hydroxy-2,5-dimethyl-3 (2H)-furanone (HDMF) in the final composition is greater than 200 ppb.

The term “colour” in the context of the present invention relates to visual perceptual property corresponding in humans to the categories called blue, green, red, etc.

The term “colour space” or “CIELAB colour space” or “L*a*b* colour space” in the context of the present invention relates to colour space parameters L*a*b* defined by International Commission on Illumination (abbreviated CIE) in 1976. L*a*b* parameters can be quantified in powders and corresponding paps on a chromameter, an instrument used to evaluate the colour of surfaces. The L*a*b* model encompasses the entire light spectrum, including colours outside human vision: the L* value indicates the level of light or dark, which ranges from 0 (black) to 100 (white), whereas parameters a* (from green to red) and b* (from blue to yellow) range from-300 to 300. In an embodiment of the present invention, the a* colour space parameter of powdered final composition is higher than 0 and a* colour space parameter of corresponding pap after the reconstitution of the powdered final composition is higher than 0.5.

In one embodiment the low sugar food composition is a pap and wherein the a*value is above 0.5.

The term “plant-based ingredient” refers to ingredients derived from plants that include vegetables, fruits, whole grains, nuts, seeds and/or legumes. In one embodiment the plant-based ingredient is selected from a group consisting of wheat, barley, rye, oat, corn, rice, bulgur, buckwheat, chia, quinoa, flaxseeds, amaranth, sesame, millet, sorghum, soy, cow pea, chickpea, and/or red lentils. In one embodiment the plant-based ingredient may be a combination of multiple ingredients described above.

The term “roasting” refers to a heating method that uses dry heat wherein cereal grains or leguminous seeds or beans are exposed for several minutes to hot air or hot surface with temperatures ranging from 120° C. to 220° C., for example 140° C. to 220° C. for time between 1 min to 600 min to transform native ingredients into roasted ingredients, which have improved organoleptic properties such as colour and flavour. Physical and chemical changes occur during the roasting transforming native ingredients into roasted ingredients.

Organoleptic properties developed during the roasting depend on roasting conditions, in particular on roasting temperature and time.

The roasting can be performed in different types of roasters There are many types of roasters that can operate in batch or continuous mode and use different heating methods. Non-exhaustive examples of roasters are drum roaster, fluidized bed roaster, spiral vibrating fluid bed roaster, roaster with superheated steam, infrared roaster, and microwave roaster. Batch size in batch mode and flow in continuous mode can also have an impact on the roasting process. Temperature and time applied during the roasting are also adapted within the claimed range to the type of roaster used as well as to batch size and flow of the roasting process.

The temperature applied during the roasting ranges from 120° C. to 220° C., for example 140° C. to 220° C., while time of roastings ranges from 1 min to 600 min. In one embodiment the roasting of the plant-based ingredient is performed at temperatures of 160 to 220° C. for 5 to 20 minutes. In one embodiment the roasting of the plant-based ingredient is performed at temperatures of 200° C. for 5 to 10 minutes.

In one embodiment of the present invention, the roasting is performed in a continuous fluidized bed adapted to flow to have residence time between 5 and 15 minutes at a temperature comprised between 130° C. and 170° C.

In another embodiment of the present invention, the roasting is performed in a continuous spiral vibrating roaster (RevTech) adapted to have residence time between 5 and 15 minutes at a temperature comprised between 190° C. and 210° C.

In another embodiment of the present invention, the roasting is performed in drum roaster operating at a temperature comprised between 120° C. and 150° C. for a time between 30 and 50 minutes.

In one embodiment, the cereal grains or leguminous seeds or beans are not germinated and/or sprouted and/or malted.

In one embodiment the amount of incorporation of roasted ingredient ranges from 2.5 to 10% w/w.

In one embodiment the roasting of the plant-based ingredient is done to such an extent that at least one of the L*a* b*colour space parameters is changed by at least 5% after the roasting. In one embodiment the roasting of the plant-based is done to such an extent that L*a* b*colour space parameters are changed by at least 10% after roasting.

In one embodiment the roasting of the plant-based ingredient is done to such an extent that the total amount of pyrazines containing 2-ethyl-6-methylpyrazine, 2-ethyl-5-methylpyrazine, 2,3,5-trimethylpyrazine, 2-ethyl-3-methylpyrazine, 2-ethyl-3,6-dimethylpyrazine and 2-ethyl-3,5-dimethylpyrazine is greater than 200 ppb after roasting.

In one embodiment the roasting of the plant-based ingredient is done to such an extent that the total amount of Strecker aldehydes containing 3-methylbutanal, 2-methylbutanal, methional and phenylacetaldehyde is greater than 1500 ppb after roasting.

In one embodiment the roasting of the plant-based ingredient is done to such an extent that the amount of 4-hydroxy-2,5-dimethyl-3 (2H)-furanone (HDMF) is greater than 2000 ppb after roasting.

The term “plant-based ingredient is adapted until” refers to the degree of roasting the plant-based ingredient and incorporation/dosage of the plant-based ingredient into preparation of a finished product which is a food composition with organoleptic properties. It should be apparent that due to the dosage in an amount ranging from 1 to 50% w/w, the amount of the aroma compounds in ppb is lower than the amounts measured in the roasted ingredient as such. Thus, the finished product obtainable by incorporation of the roasted plant-based ingredient results in a finished product comprising the total amount of pyrazines containing 2-ethyl-6-methylpyrazine, 2-ethyl-5-methylpyrazine, 2,3,5-trimethylpyrazine, 2-ethyl-3-methylpyrazine, 2-ethyl-3,6-dimethylpyrazine and 2-ethyl-3,5-dimethylpyrazine in amount greater than 20 parts per billion (ppb). Similarly, the finished product comprises Strecker aldehydes containing 3-methylbutanal, 2-methylbutanal, methional and phenylacetaldehyde greater than 150 ppb. Similarly, the finished product comprises amount of 4-hydroxy-2,5-dimethyl-3 (2H)-furanone (HDMF) greater than 200 ppb.

### Methodology

### Roasting in Oven

100 g of material (white or red quinoa seeds, wheat grains, soybeans) were spread out on a baking paper and roasted in a convective oven (Memmert) at 200° C. for 5, 10, 15, 20 minutes. After the roasting, samples were left to cool down at ambient temperature.

### Roasting in Spiral Vibrating Roaster

15 Kg of the material was transferred into a spiral vibrating roaster. The tube of the roaster was heated to temperature of 200° C. and vibrations were set to ensure flow corresponding to approximately 5 min per cycle. The material was passed through the spiral three times that was accounted for 15 min roasting time.

### Grinding of Roasted Ingredients

Roasted ingredients were grinded using a kitchen coffee grinder (Moulinex). Grinding conditions were standardized by defined amount of sample (30 g) and time of grinding (20 s) to obtain flours with similar granulometry.

### Preparation of Processed Cereal-Based Product

Processed cereal-based product discussed in the context of the present invention was obtained in a retail shop or prepared in a pilot plant or a factory trial. The list of products presented for the examples is shown in Table 2. The process of preparation of cereal-based product comprises following steps:
1. Preparation of the slurry: flour of one or more cereal types is homogenized with water. Other ingredients such as sugars, oils and fats, mineral salts or milk powders, etc. can be optionally added. The slurry usually undergoes enzymatic in-line hydrolysis process with alpha-amylase to reduce the viscosity. Optionally, partial hydrolysis of the cereal flours with alpha-amylases and/or amyloglucosidase can also be performed depending on sugar amount targeted in the finished product. Such hydrolysis is usually performed separately, and conditions of the hydrolysis and proportion of hydrolysed cereals in finished product is established based on targeted sugar amount. Products having low sugar amounts (<2% dm of mono- and di-saccharides) do not undergo any hydrolysis nor contain any added sugar.
2. Steam injection: steam is injected to the slurry to reach the temperature above 120° C. for at least 20 s for hygienic reasons and enzymes inactivation.
3. Roller-drying: the slurry (comprising typically solids from 30% to 50%, w/w) is subjected to a roller drying. Temperature (defined by drum pressure) and roller speed is adapted to obtain optimal film formation with sufficient throughput and to ensure targeted product moisture (typically from 2% to 4%), organoleptic quality while keeping amounts of process contaminants as low as possible.
4. Milling of the film: film obtained after the roller-drying is milled to obtain a semi-finished powdered product, so called base powder.
5. Dry-mixing: base powder is dry-mixed with thermolabile ingredients (vitamin and mineral premix, probiotics, flavouring ingredients, etc.) to obtain finished product. If the product is meant to be reconstituted in the water, milk powder is also added at this stage to produce so called complete product.

TABLE 2
Processed cereal-based products obtained in a retail
shop or prepared in a pilot plant or a factory trial.

| | | | Total | | |
|---|---|---|---|---|---|
| | | | sugars* | | Cereal |
| Product | Product | | (g/100 | | hydro- |
| code | type | Reconstitution | g) | Grain type | lysis |
| P1 | Standard | 18 g/160 mL milk | 1.2 | Multicereals | No |
| P2 | Complete | 40 g/150 ml water | 1.5 | Wheat | Yes |
| P3 | Standard | 18 g/160 mL milk | 1.6 | Wheat | No |
| P4 | Standard | 18 g/160 mL milk | 0.5 | Rice | No |
| P5 | Standard | 17 g/160 ml milk | 1.6 | Multicereals | No |
| P6 | Standard | 18 g/160 mL milk | 1.3 | Buckwheat | No |
| P7 | Standard | 18 g/160 mL milk | 0 | Oat | No |
| P8 | Standard | 25 g/160 mL milk | 18.4 | Multicereals | Yes |
| P9 | Standard | 25 g/160 mL milk | 20.8 | Multicereals | Yes |
| P10 | Complete | 50 g/150 ml water | 10.0 | Wheat | Yes |
| P11 | Complete | 50 g/150 ml water | 22.0 | Wheat | Yes |
| P12 | Complete | 50 g/150 ml water | 20.0 | Wheat | Yes |

*Naturally occurring lactose from milk powder present in complete products is not included.

Preparation of Mixes of Processed Cereal-Based Product with Roasted Ingredients

Defined amounts of processed cereal-based product and flour of roasted ingredient were thoroughly mixed in a plastic beaker with a screw cap for at least 2 min. The composition of individual mixes is depicted in Table 6.

### Preparation of Pap

Depending on product type, the powder was reconstituted either in milk (1.5% fat) or in water at temperature between 45° and 55° C. Warm milk or water was transferred into a bowl and the powder was gradually added under continuous stirring to create a pap. Amounts of the powder and milk or water used for the reconstitution of each product are provided in Table 2. When the pap was prepared from the mix of the product with native or roasted ingredient, the amount of the powder was same as stated for the original product.

### Analysis of Colour

The colour of powders and paps was assessed by measuring the CIE (Commission Internationale de l'Eclairage) colour space parameters (L*a*b*) using a Chroma meter CR-410 (Konica Minolta). This model encompasses the entire light spectrum, including colours outside human vision: the L* value indicates the level of light or dark, which ranges from 0 (black) to 100 (white), whereas parameters a* (from green to red) and b* (from blue to yellow) range from-300 to 300. A powdered sample or pap was transferred into a glass cuvette up to about 2 to 3 cm height. If necessary, large bubbles created on the bottom of the cuvette filled with the pap were removed by mixing with a spatula. The colour was measured from the bottom of the cuvette to ensure good homogeneity and smoothness of the surface. Two independent measurements were performed, and the average value was calculated. During duplicate measurement of same sample, the cuvette was emptied and filled again. Before each measurement, the instrument was controlled and, if necessary, calibrated with reference calibration plate provided by the supplier.

### Analysis of Acrylamide

Concentration of acrylamide was determined by method based on European Standard EN 16618:2015 for the quantitative determination of acrylamide by LC-MS/MS. Validation was performed according to the quality criteria described in the EU Commission Decision 2017/2158. The protocol involves an initial extraction with water while isooctane is simultaneously added for defatting purpose. After shaking and centrifugation, the supernatant is collected and diluted with water (1+1) before being purified by two successive solid phase extraction (SPE) cartridges (Isolute® Multimode and Isolute® ENV+®). Eventually, the SPE eluate is partially evaporated and analysed by High Performance Liquid Chromatography coupled with tandem Mass Spectrometry (HPLC-MS/MS). The data were acquired in positive electrospray ionisation (ESI+) using multiple reaction monitoring mode (MRM). Monitoring of at least two fragmentation transitions was accomplished for confirmatory purpose. Quantification was achieved by Stable Isotope Dilution Analysis (SIDA) with use of [²H₃]-acrylamide as labelled internal standard (added prior to the extraction step to ensure accurate quantitation). Respective MRM transitions used for the quantification are shown in Table 3.

### Analysis of Furan

The content of furan was determined using Head Space Solid Phase Micro Extraction in combination with Gas Chromatography and Mass Spectrometry (HS-SPME-GC/MS). Quantification was accomplished by external calibration curve established with use of [²H₄]-furan.

The sample (500±2.5 mg) was exactly weighted and mixed with 10 mL of refrigerated solution of sodium chloride (300 g/L) in 20 mL headspace vial. After addition of aqueous solution of labelled standard (50 μL), the mixture was homogenized by means of a Vortex agitator for at least 5 s. Each sample was prepared in duplicates by two independent work-ups.

HS-SPME extraction was performed at 50° C. for 20 min under agitator speed of 750 rpm using DVB/PDMS fiber of 2 cm (Supelco). The fiber was injected into a GC-MS instrument and analyte was desorbed in splitless mode at 250° C. for 1 min.

For GC/MS, an Agilent 7890A gas chromatograph and Agilent 5975C single quadrupole mass spectrometer were used. Gas chromatographic separations were achieved on a DB-624-MSUI column 30 m×0.25 mm i.d., film thickness 1.4 μm (J&W Scientific) with a gradient starting at 45° C. for 1 min, a ramp of 3° C./min to 70° C. was followed by a second ramp of 100° C./min to 240° C. and maintained constant for 4 min. Helium was used as a carrier gas with a constant flow of 0.75 mL/min. Mass spectrometry was performed in selected ion monitoring mode (SIM). At least two fragmentation ions were monitored for confirmatory purpose. Respective quantifiers are shown in Table 3.

### Analysis of Strecker Aldehydes and Pyrazines

Four Strecker aldehydes and six pyrazines (Table 3) were determined using Head Space Solid Phase Micro Extraction in combination with Gas Chromatography and tandem Mass Spectrometry (HS-SPME-GC/MS/MS). Quantification was accomplished by Stable Isotope Dilution Analysis (SIDA) with use of corresponding labelled standards (isotopomers). For some pyrazines, corresponding labelled standards were not available, thus the quantification was accomplished with a labelled pyrazine having a similar structure to the analyte (see Table 3), while response factors were calculated and used to correct the results.

The sample (500±2.5 mg) was mixed with 10 ml of solution of sodium chloride in water (300 g/L) in 20 mL headspace vial. After addition of methanol solution of labelled standards (50 μL), the mixture was homogenized by means of a Vortex agitator for at least 5 s. Each sample was prepared in duplicates by two independent work-ups.

HS-SPME extraction was performed at 80° C. for 10 min under agitator speed of 500 rpm using DVB CAR-PDMS fiber of 2 cm (Supelco). The fiber was injected into a GC-MS/MS instrument and aroma compounds were desorbed in split mode (ratio 1:1) at 250° C. for 1 min.

For GC/MS, an Agilent 7890A gas chromatograph and Agilent 7010 triple quadrupole mass spectrometer with high sensitivity electron ionization source (HS-EI) were used. Gas chromatographic separations were achieved on a DB-624-MSUI column 30 m×0.25 mm i.d., film thickness 1.4 μm (J&W Scientific). The temperature program of the oven started at 40° C.; the temperature raised by 20° C./min to 240° C. and maintained constant for 4 min. Helium was used as a carrier gas with a constant flow of 0.75 mL/min. Mass spectrometry (MS) was performed in multiple-reaction-monitoring (MRM) mode. At least two fragmentation transitions were monitored for each analyte for confirmatory purpose. MRM transitions used for the quantification of respective compounds are listed in Table 3.

### Analysis of HDME

Content of 4-hydroxy-2,5-dimethyl-3 (2H)-furanone (HDMF) was determined by Ultra-High-Performance Liquid Chromatography coupled with tandem Mass Spectrometry (UPLC-MS/MS). Sample (1 g) was dissolved in water (10 mL). The solution was centrifuged and filtered using a 0.2 μm syringe filter to remove impurities. A sample volume of 5 μL was injected at a flowrate of 0.4 mL/min with acetonitrile:water containing formic acid (0.1%) at ratio 5:95 as the mobile phase. Chromatographic separations were achieved on a column maintained at 40° C. (Kinetex® 1.7 μm Phenyl-Hexyl 100 Å LC Column 100×2.1 mm), coupled with a MS detector (QTrap 6500). The data were acquired in a positive electrospray ionisation (ESI+) using multiple reaction monitoring mode (MRM). Monitoring of at least two fragmentation transitions was accomplished for confirmatory purpose. Quantification was achieved by external HDMF standard of high-purity by method of calibration curve. Calibration curve with 6 concentration points was established in each series of analysis. MRM transition used for the quantification is shown in Table 3.

### Analysis of Sugars

The content of five sugars (fructose, glucose, sucrose, maltose, lactose) was determined by High-Performance Liquid Chromatography coupled with Refractive Index Detector (HPLC-RID). Sample (2 g) was dissolved in water (75 mL) and sugars were extracted at 70° C. for 20 min in a water bath. The solution was cleaned up by precipitation with Carrez solutions, made up to volume (100 mL) by addition of water and filtered using a 0.2 μm syringe filter to remove impurities. A sample volume of 20 μL was injected at a flowrate of 1 mL·min-1 with acetonitrile:water (73:27) as the mobile phase. Chromatographic separations were achieved on a column maintained at 25° C. (Waters Polyamin II, Stagroma Art PB12S05-2546WT, 4 μm, 4.6×250 mm), coupled with a refractive index detector (Shodex RI-101), maintained at 40° C. Individual sugars were identified and quantified based on retention times and integration of peak area, respectively, by comparing against known sugar standards of high-purity. Results are expressed as g sugar/100 g sample, after correcting for the anhydrous mass of the sugar. The method used for sugar analyses has limit of detection (LoD) established as 0.3 g sugar/100 g sample and limit of quantification (LoQ) as 0.5 g sugar/100 g sample. Following rule was applied to calculate total sugar amount: in the case where one or several sugars were present below LoQ but above LoD (in amount called ‘traces’), the absolute value of LoQ was taken into account. In the case where one or several sugars were below LoD, their amount were neglected and considered as zero in the calculation.

### Sensory Analysis

Sensory analyses of powders (aroma, colour, and appearance) and paps (colour, texture, aroma, taste, and appearance) were performed by at least 5 trained assessors using a method of “free comment analysis”. The assessors were requested to describe sensory attributes of the samples openly and spontaneously.

### Statistical Analysis

Statistical analysis of the data was performed in Excel program (Microsoft) using ‘box and whisker’ chart. A ‘box and whisker’ chart shows distribution of data into quartiles, highlighting the mean, median, the lowest and highest data points as well as outliers. The boxplot represents 50% of the data set, distributed between the 1st and 3rd quartiles. The line inside the box indicates median, while the cross indicates mean. The lines extending the boxes vertically (so called ‘whiskers’) indicate the lowest and highest data points. The points outside the boxes and whiskers are outliers.

TABLE 3
List of monitored compounds along with corresponding methods used for their quantification (MRM - multiple reaction
monitoring mode in triple quadrupole system, SIM - selected ion monitoring mode in single quadrupole system)

| | | MRM | | MRM |
|---|---|---|---|---|
| | | transition/ | | transition/ |
| | | quantifier | | quantifier |
| Analyte | Method | (m/z) | Internal/external standard | (m/z) |
| 3-methylbutanal | SPME-GC-MS/MS | 86 → 58 | [²H₇]-3-methybutanal | 93 → 63 |
| 2-methylbutanal | SPME-GC-MS/MS | 86 → 58 | [²H₃]-2-methylbutanal | 89 → 61 |
| methional | SPME-GC-MS/MS | 104 → 48 | [²H₃]-methional | 107 → 51 |
| phenylacetaldehyde | SPME-GC-MS/MS | 120 → 91 | [¹³C₂]-phenylacetaldehyde | 122 → 92 |
| 2-ethyl-6-methylpyrazine | SPME-GC-MS/MS | 122 → 121 | [²H₁₀]- 2,3,5-trimethylpyrazine | 132 → 46 |
| 2-ethyl-5-methylpyrazine | SPME-GC-MS/MS | 122 → 121 | [²H₁₀]- 2,3,5-trimethylpyrazine | 132 → 46 |
| 2,3,5-trimethylpyrazine | SPME-GC-MS/MS | 122 → 42 | [²H₁₀]- 2,3,5-trimethylpyrazine | 132 → 46 |
| 2-ethyl-3-methylpyrazine | SPME-GC-MS/MS | 122 → 121 | [²H₁₀]- 2,3,5-trimethylpyrazine | 132 → 46 |
| 2-ethyl-3,6-dimethylpyrazine | SPME-GC-MS/MS | 136 → 107 | [²H₅]- 2-ethyl-3,5-dimethylpyrazine | 141 → 109 |
| 2-ethyl-3,5-dimethylpyrazine | SPME-GC-MS/MS | 136 → 107 | [²H₅]- 2-ethyl-3,5-dimethylpyrazine | 141 → 109 |
| furan | SPME-GC-MS | 68 (SIM) | [²H₄]-furan | 72 (SIM) |
| acrylamide | HPLC-MS/MS | 72 → 55 | [²H₃]-acrylamide | 75 → 58 |
| 4-hydroxy-2,5-dimethyl-3(2H)- | UPLC-MS/MS | 129 → 43 | 4-hydroxy-2,5-dimethyl-3(2H)- | 129 → 43 |
| furanone | | | furanone | |
| fructose | HPLC-RID | | fructose | |
| glucose | HPLC-RID | | glucose | |
| sucrose | HPLC-RID | | sucrose | |
| maltose | HPLC-RID | | maltose | |
| lactose | HPLC-RID | | lactose | |

### Example 1: Roasting of Ingredients

In total, 8 ingredients comprising white and red quinoa, amaranth, wheat, barley, rye, buckwheat, and soy were roasted at 200° C. for different times in a laboratory scale convective oven or in a pilot plant scale spiral vibrating roaster. The overview of conditions applied in respective roasting trials is provided in Table 4. Table 4 also summarizes colour space parameters (L*a*b*) measured in flours obtained after the grinding of roasted ingredients or selected native (non-roasted) ingredients and depicts content of aroma markers such as sum of Strecker aldehydes, sum of pyrazines and HDMF.

Table 5 depicts L*a*b* deviations between selected native ingredients (white quinoa, red quinoa, wheat, and soy) and corresponding ingredients roasted in oven at 200° C. for 10 min. In general, colour space parameter a* was found the most differentiating for the colour change during the roasting and it is therefore used in following examples to define the roast degree of the ingredients. The a* value is also one of criteria to define the colour of the powder and corresponding pap of finished product summarized in Table 6.

This example demonstrated that at least one of the L*a*b* colour space parameters changes at least by 5% after the roasting.

TABLE 4
Native and roasted ingredients used for the preparation of processed cereal-based products
along with L*a*b* colour space parameters and concentrations of aroma markers

| | | | | | | | SUM of | | |
|---|---|---|---|---|---|---|---|---|---|
| | | Roasting | Roasting | | | | Strecker | SUM of | |
| | Roasting | temperature | time | | | | aldehydes | pyrazines | HDMF |
| Ingredient | equipment | (° C.) | (min) | L* | a* | b* | (ppb) | (ppb) | (ppb) |
| white quinoa | oven | 200 | 5 | 86.29 | 0.85 | 16.31 | 6486 | n.a. | 1879 |
| white quinoa | oven | 200 | 10 | 71.41 | 5.89 | 17.95 | 5821 | 4077 | 13419 |
| red quinoa | oven | 200 | 10 | 58.59 | 5.63 | 12.35 | 5670 | 6343 | 19950 |
| red quinoa | oven | 200 | 15 | 55.16 | 5.58 | 11.17 | 13251 | n.a. | 26318 |
| wheat | oven | 200 | 10 | 71.58 | 4.88 | 15.66 | 3643 | 3857 | 6929 |
| wheat | oven | 200 | 20 | 64.44 | 5.73 | 15.46 | 6647 | n.a. | 19034 |
| soy | oven | 200 | 10 | 69.26 | 7.53 | 21.50 | 3690 | 5183 | 17940 |
| amaranth | spiral | 200 | 15 | 64.18 | 7.71 | 17.29 | 4789 | 5816 | 21244 |
| | roaster | | | | | | | | |
| barley | spiral | 200 | 15 | 77.62 | 3.94 | 15.57 | 5073 | 1771 | 6016 |
| | roaster | | | | | | | | |
| buckwheat | spiral | 200 | 15 | 75.88 | 4.64 | 13.31 | 2392 | 2310 | 6185 |
| | roaster | | | | | | | | |
| rye | spiral | 200 | 15 | 77.55 | 3.73 | 13.88 | 5946 | 4734 | 8347 |
| | roaster | | | | | | | | |

| | | | | | | | |
|---|---|---|---|---|---|---|---|
| white quinoa | non-roasted (native) | 86.73 | 0.17 | 11.46 | 69 | 0 | 0 |
| red quinoa | non-roasted (native) | 69.49 | 3.89 | 10.02 | 626 | 0 | 0 |
| wheat | non-roasted (native) | 74.58 | 4.15 | 12.89 | 138 | 0 | 0 |
| soy | non-roasted (native) | 83.56 | −0.01 | 22.81 | 143 | 0 | 0 |

(n.a. - data not available)

TABLE 5
L*a*b* deviations between selected native ingredients and corresponding
ingredients roasted in oven at 200° C. for 10 min

| | | | Ingredient | |
|---|---|---|---|---|
| Colour space | | Native | roasted in oven | Deviation |
| parameter | Ingredient | ingredient | (200° C./10 min) | (%) |
| L* | white quinoa | 86.73 | 71.41 | −18 |
| | red quinoa | 69.49 | 58.59 | −16 |
| | wheat | 74.58 | 71.58 | −4 |
| | soy | 83.56 | 69.26 | −17 |
| a* | white quinoa | 0.17 | 5.89 | 3365 |
| | red quinoa | 3.89 | 5.63 | 45 |
| | wheat | 4.15 | 4.88 | 18 |
| | soy | −0.01 | 7.53 | 75200 |
| b* | white quinoa | 11.46 | 17.95 | 57 |
| | red quinoa | 10.02 | 12.35 | 23 |
| | wheat | 12.89 | 15.66 | 21 |
| | soy | 22.81 | 21.50 | −6 |

### Example 2: Product of Invention

Eight examples of product of invention are provided in Table 6 (Case 1, Samples 1-8). Seven products (Samples 1-7) were prepared from “standard” processed cereal-based product P1 by dry mixing of 95% P1 with 5% respective roasted ingredient (white quinoa, red quinoa, wheat, soy, amaranth, barley, buckwheat). One product was prepared from “complete” processed cereal-based product P2 by dry mixing of 97.5% P2 with 2.5% white quinoa.

All nine parameters defining the features of the product of invention were analysed and found compliant with defined criteria (see Table 6 for respective values).

This example demonstrated that specific ingredients roasted to a specific degree and introduced in a specific dosage improve organoleptic quality (colour and flavour) of processed cereal-based product, while keeping product safety (low levels of process contaminants: furan and acrylamide) and nutritional superiority (low sugar levels). Addition of roasted ingredient was identified as the solution to drive consumer preference in low-sugar recipes, which suffer from poor organoleptic quality (bland flavour and pale colour).

TABLE 6
Nine parameters and compliance with criteria defined for product of invention for six cases described
in Examples 2-7 (cells in grey indicate values compliant with criteria of the product of the invention)

| | | | | | | Criteria defined for the | | |
|---|---|---|---|---|---|---|---|---|
| | | | | | | product of invention | | |
| | | | | | | 1 | 2 | |
| | | | | | | Colour | Colour | 3 |
| | | | | | | of powder | of pap | Furan |
| Product | | Sample | Cereal | Roasted | | (a*) | (a*) | (ppb) |
| type | Case | number | product | ingredient | Roasting | >0 | >0.5 | <50 ppb |
| Low-sugars | Case 1 | 1 | 95% P1 | 5% white | oven | 1.37 | 1.45 | 4.8 |
| products | Product | | | quinoa | 200° C./ | | | |
| | | | | | 10 min | | | |
| | of | 2 | 95% P1 | 5% red | oven | 1.74 | 2.42 | 9.2 |
| | invention | | | quinoa | 200° C./ | | | |
| | | | | | 10 min | | | |
| | | 3 | 95% P1 | 5% wheat | oven | 0.98 | 1.18 | 5.9 |
| | | | | | 200° C./ | | | |
| | | | | | 10 min | | | |
| | | 4 | 95% P1 | 5% soy | oven | 1.36 | 1.68 | 0.5 |
| | | | | | 200° C./ | | | |
| | | | | | 10 min | | | |
| | | 5 | 95% P1 | 5% amaranth | spiral | 2.04 | 2.20 | 3.8 |
| | | | | | roaster | | | |
| | | | | | 200° C./ | | | |
| | | | | | 15 min | | | |
| | | 6 | 95% P1 | 5% barley | spiral | 0.93 | 0.78 | 1.4 |
| | | | | | roaster | | | |
| | | | | | (200° C./ | | | |
| | | | | | 15 min | | | |
| | | 7 | 95% P3 | 5% buckwheat | spiral | 1.25 | 1.57 | 2.8 |
| | | | | | roaster | | | |
| | | | | | 200° C./ | | | |
| | | | | | 35 min | | | |
| | | 8 | 97.5% P2 | 2.5% white | oven | 0.07 | 1.06 | 2.4 |
| | | | | quinoa | 200° C./ | | | |
| | | | | | 10 min | | | |
| | Case 2 | 9 | 95% P1 | 5% white | oven | | | |
| | Product | | | quinoa | 200° C./ | | | |
| | with under- | | | | 5 min | | | |
| | roasted/ | 10 | 95% P1 | 1% white | oven | | | |
| | dosed | | | quinoa | 200° C./ | | | |
| | ingredients | | | | 10 min | | | |
| | | 11 | 99% P1 | 1% white | oven | | | |
| | | | | quinoa | 200° C./ | | | |
| | | | | | 5 min | | | |
| | Case 3 | 12 | 95% P1 | | spiral | | | 4.9 |
| | Product | | | | roaster | | | |
| | with over- | | | | 200° C./ | | | |
| | roasted/ | | | | 15 min | | | |
| | dosed | 13 | 80% P1 | 20% red | oven | | | 82 |
| | ingredients | | | quinoa | 200° C./ | | | |
| | | | | | 15 min | | | |
| | | 14 | 95% P1 | 5% wheat | oven | | | 24 |
| | | | | | 200° C./ | | | |
| | | | | | 20 min | | | |
| | Case 4 | 15 | 95% P1 | 5% white | non-roasted | 0.52 | 0.11 | |
| | Product | | | quinoa | (native) | | | |
| | with | 16 | 95% P1 | 5% red | non-roasted | 0.76 | 1.09 | |
| | native (non- | | | quinoa | (native) | | | |
| | toasted) | 17 | 95% P1 | 5% wheat | non-roasted | 0.57 | 0.36 | |
| | ingredients | | | | (native) | | | |
| | | 18 | 95% P1 | 5% soyt | non-roasted | 0.43 | 0.25 | |
| | | | | | (native) | | | |
| | Case 5 | 19 | 100% P1 | | | 0.41 | 0.16 | |
| | Product | | | | | | | |
| | without | 20 | 100% P2 | | | −1.69 | −1.58 | |
| | roasted | | | | | | | |
| | ingredient | 21 | 100% P3 | | | −0.03 | −1.00 | |
| | | 22 | 100% P4 | | | −0.4 | −3.01 | |
| | | 23 | 100% P5 | | | 1.37 | 1.23 | |
| | | 24 | 100% P6 | | | 4.18 | 3.65 | |
| | | 25 | 100% P7 | | | 0.87 | −0.09 | |
| | Case 6 | 26 | 100% P8 | | | 1.44 | 1.47 | |
| | High-sugars | 27 | 100% P9 | | | 1.43 | 1.65 | |
| | products | 28 | 100% P10 | | | −0.02 | 0.62 | |
| | without | 29 | 100% P11 | | | 2.97 | 3.65 | |
| | roasted | 30 | 100% P12 | | | 2.67 | 3.94 | |
| | ingredients | | | | | | | |

| | | | Criteria defined for the product of invention | | | | | |
|---|---|---|---|---|---|---|---|---|
| | | | | 5 | | | | 9 |
| | | | | SUM of | 6 | | 8 | Favour |
| | | | 4 | Strecker | SUM of | 7 | SUM of | of the |
| | | | Acrylamide | aldehydes | pyrazines | HDMF | sugars | pap |
| Product | | Sample | (ppb) | (ppb) | (ppb) | (ppb) | (g/100 g) | toasty |
| type | Case | number | <60 ppb | >150 ppb | >20 ppb | >200 ppb | <5 g/100 g | roasty |
| Low-sugars | Case 1 | 1 | 6.8 | 432 | 177 | 902 | 1.12 | toasty, |
| products | Product | | | | | | | roasty |
| | of | 2 | 14 | 523 | 380 | 1562 | 1.18 | toasty, |
| | invention | | | | | | | roasty |
| | | 3 | 44 | 444 | 277 | 665 | 1.09 | toasty, |
| | | | | | | | | roasty |
| | | 4 | 5.8 | 451 | 324 | 1752 | 0.63 | toasty, |
| | | | | | | | | roasty |
| | | 5 | 8.5 | 357 | 284 | 1541 | 1.04 | toasty, |
| | | | | | | | | roasty |
| | | 6 | 8.5 | 673 | 118 | 562 | 1.36 | toasty, |
| | | | | | | | | roasty |
| | | 7 | 5.5 | 254 | 89 | 586 | 1.46 | toasty, |
| | | | | | | | | roasty |
| | | 8 | 3.4 | 160 | 86 | 458 | 1.26 | toasty, |
| | | | | | | | | roasty |
| | Case 2 | 9 | | 349 | 38 | 169 | | cereal, |
| | Product | | | | | | | milky |
| | with under- | 10 | | 148 | 38 | 181 | | cereal, |
| | roasted/ | | | | | | | milky |
| | dosed | 11 | | 133 | 7 | 46 | | cereal, |
| | ingredients | | | | | | | milky |
| | Case 3 | 12 | 106 | | | | | toasty, |
| | Product | | | | | | | roasty |
| | with over- | 13 | 64 | | | | | toasty, |
| | roasted/ | | | | | | | roasty |
| | dosed | 14 | 62 | | | | | toasty, |
| | ingredients | | | | | | | roasty |
| | Case 4 | 15 | | 92 | 0 | 0 | | cereal, |
| | Product | | | | | | | milky |
| | with | 16 | | 120 | 0 | 0 | | cereal, |
| | native (non | | | | | | | milky |
| | toasted) | 17 | | 95 | 0 | 0 | | cereal, |
| | ingredients | | | | | | | milky |
| | | 18 | | 96 | 0 | 0 | | cereal, |
| | | | | | | | | milky |
| | Case 5 | 19 | | 93 | 0 | 128 | 1.24 | cereal, |
| | Product | | | | | | | milky |
| | without | 20 | | 34 | 0 | 61 | 1.49 | cereal, |
| | roasted | | | | | | | milky |
| | ingredient | 21 | | 72 | 0 | 61 | 1.60 | cereal, |
| | | | | | | | | milky |
| | | 22 | | 9 | 0 | 0 | 0.50 | cereal, |
| | | | | | | | | milky |
| | | 23 | | 87 | 0 | 1508 | 1.58 | caramel |
| | | 24 | | 114 | 0 | 151 | 1.26 | cereal, |
| | | | | | | | | milky |
| | | 25 | | 35 | 0 | 70 | 0 | cereal, |
| | | | | | | | | milky |
| | Case 6 | 26 | | 603 | 0 | 55 | 18.4 | sweet, |
| | High-sugars | | | | | | | cookie |
| | products | 27 | | 674 | 0 | 14175 | 20.8 | sweet, |
| | without | | | | | | | cookie, |
| | roasted | | | | | | | caramel |
| | ingredients | 28 | | 996 | 2 | 139 | 10.0 | sweet, |
| | | | | | | | | cookie |
| | | 29 | | 1750 | 1 | 199 | 22.0 | sweet, |
| | | | | | | | | cookie |
| | | 30 | | 1012 | 0 | 246 | 20.0 | sweet, |
| | | | | | | | | cookie |

### Example 3: Product with Under-Roasted and/or Under-Dosed Roasted Ingredient

This example shows importance of right roast degree and right dosage to achieve desirable technical effect. In particular, it demonstrates that under-roasted and/or under-dosed roasted ingredient does not deliver desirable flavour and required levels or aroma markers. Three products (Samples 9-11) were prepared by dry-mixing of processed cereal-based product P1 with roasted white quinoa. Sample 9 was made from 95% P1 and 5% white quinoa roasted to light colour (5 min at 200° C., a*=0.85). Sample 10 was prepared with same white quinoa roasted to darker colour (10 min at 200° C., a*=5.89), but applied in P1 in reduced dosage of 1%. Finally, Sample 11 was prepared was from 99% P1 and 1% light roast white quinoa.

As shown in Table 6 (Case 2, Samples 9-11), none of the three samples delivered desirable flavour with distinct toasty, roasty flavour (Parameter 9) and did not achieve required levels of HDMF>200 ppb. Levels of Strecker aldehydes in Samples 10,11 were below required limit, while Sample 11 had all three aroma markers (Parameters 5-7) below defined limit.

This example demonstrates the limitations of the technology and narrow window in which we can operate to achieve desirable technical effect.

### Example 4: Product with Over-Roasted and/or Over-Dosed Roasted Ingredient

This example shows importance of right roast degree and right dosage to achieve desirable technical effect. In particular, it demonstrates that over-roasted and/or over-dosed roasted ingredients increase level of process contaminants (furan and acrylamide) to the levels that can rise safety concern and therefore is not acceptable, especially in food products intended for infants and young children.

Three products (Table 6, Case 3, Samples 12-14) were prepared by dry-mixing of processed cereal-based product P1 with roasted rye, red quinoa and wheat applied at different roast degrees and dosages. Sample 12 containing 5% roasted rye (200° C.@15 min, a*=3.73) contained 106 ppb acrylamide and exceed thus more than double the limit defined for the product of invention (50 ppb). This pointed out the extraordinary potential of ray to generate this process contaminant as other ingredients roasted under same or similar conditions and introduced at the same dosage (Samples 1-7) revealed much lower acrylamide levels (from 5.5 to 44 ppb).

Sample 13 containing 20% roasted red quinoa (200° C.@15 min, a*=5.58) exceeded the defined limits for both process contaminants having furan level at 82 ppb and acrylamide level at 64 ppb.

Sample 14 demonstrated that increase of time of wheat roasting (200° C.) from 10 to 20 min increase acrylamide amount in P1 product with 5% wheat from 44 to 62 ppb and thus makes it not compliant with criterium defined for the product of invention setting acrylamide limit to 60 ppb.

This example demonstrates the limitations of the technology and narrow window in which we can operate to achieve desirable technical effect.

### Example 5: Products with Native Vs. Roasted Ingredients

This example demonstrates the effect of roasted ingredients in the product of invention. To demonstrate this effect four products were prepared by dry-mixing of product P1 with respective native (non-roasted) ingredients white quinoa, red quinoa, wheat, and soy (Table 6, Case 4, Samples 15-18). Samples 15-18 were prepared from same batch of P1 product and same batches of white quinoa, red quinoa, wheat, and soy as Samples 1˜4 (products of invention) containing their roasted counterparts. Due to same inclusion rate (5%) comparison of Samples 15-18 and Samples 1-4, thus allow direct evaluation of the impact of roasting on the features of the finished product.

Impact of roasting on change of ingredient colour is evidenced in Table 5. For example, for the roasting in the oven at 200° C. for 10 min, colour space value a* changes as follows: 0.17→5.89 for white quinoa, 3.89→5.63 for red quinoa, 4.15→4.88 for wheat and −0.01→7.53 for soy.

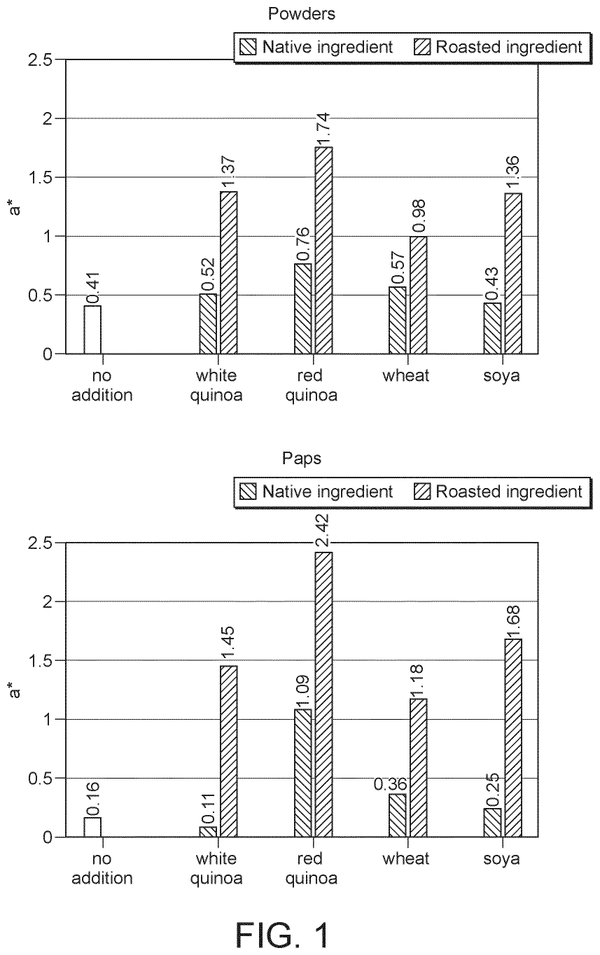

FIG. 1 demonstrates the impact of 5% native and 5% roasted ingredient on the colour of product P1 measured in the powder and corresponding pap. It was evidenced that addition of roasted ingredients results in significant increases of a* value, compared to original P1 product. The increase of a* value was by far higher in paps (increases between 638% to 1413%) than in powders (increase between 139% to 324%). On the other hand, only small colour changes were observed in Samples 15-18 containing native ingredients (increases between 5% and 85% for powders and variation between-31% to 581% for paps). The a* value measured using a Chroma meter correlated well with visual observation of the samples, while yellowish, brownish colour increased with increasing a* value.

For the powders, the a* value measured in Samples 15-18 was higher than 0, thus compliant with the limit defined for the product of invention. Nevertheless, in paps, only Sample 16 with native red quinoa showed higher a* value (1.09), all other samples revealed values from 0.11 to 0.36, thus below the a* limit of 0.5 defined for the product of invention. High a* value measured in the Sample 16 with native red quinoa is linked to the natural colour of this ingredient.

None of the Samples 15-18 with native ingredients complied with the levels of aroma markers (Parameters 5-7) defined for the product of invention. Sum of Strecker aldehydes in Samples 15-18 ranged from 92 to 120 ppb. Levels of pyrazines and HDMF were below the detection limit. On the other hand, levels of all aroma markers were significantly increased in corresponding Samples 1˜4 with roasted ingredients (product of invention): Strecker aldehydes ranged from 432 to 523 ppb, pyrazines ranged from 177 to 380 ppb and HDMF ranged from 665 to 1752 ppb.

The flavour of the pap (Parameter 9) in Samples 15-18 was not compliant with the requirement and was described as cereal, milky. The Samples 15-18 had flavour comparable to Sample 19 (100% P1) suggesting thus that native ingredients have no impact on the flavour. On the other hand, distinct roasty, toasty flavour we perceived in Samples 1˜4 with roasted ingredients.

### Example 6: Low-Sugar Products without Roasted Ingredients

This example demonstrates the problem solved in the present invention. Processed cereal-based food products with no added nor produced sugars are gaining a significant attention from both health authorities and the consumers, however organoleptic quality (pale colour and bland flavour) make those products often less attractive for the consumers.

To demonstrate the problem of poor organoleptic quality in low-sugars products, seven products P1-P7 (Table 6, Case 5, Samples 19-25) were collected in a retail shop or prepared in a pilot plant or a factory trial. The amount of sugars determined in products P1-P7 ranged from 0 to 1.60 g/100 g. The flavour of those products (Parameter 9) was described as milky, cereals or whole grain with the only exception of product P5 (Sample 23) that had distinct caramel flavour, which is delivered through the flavouring that was declared in the ingredient list.

None of the products P1-P7 complied with aroma markers criteria (Parameters 5-7) defined for the product of invention. Levels of Strecker aldehydes in those samples ranged from 9 to 114 ppb and the pyrazines were below the detection limit in all samples. No or very low HDMF levels (0-151 ppb) were detected in low-sugar products apart from product P5. In the product P5, elevated HDMF amount (1508 ppb) suggest presence of this aroma compound in commercial flavouring and is well in line with the caramel flavour of this product. Interestingly, comparable levels of HDMF are delivered by our invention through the roasted ingredients (HDMF levels from 458 to 1752 ppb were determined in products of invention: Samples 1-8).

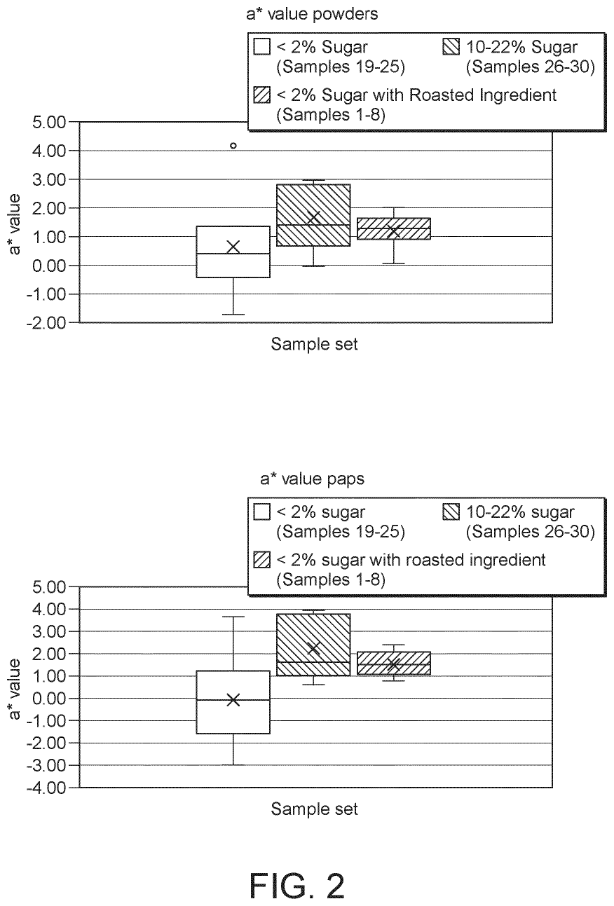

Poor organoleptic quality of low-sugar products can also be demonstrated through the colour. FIG. 2 shows the result of statistical analysis, which was performed to demonstrate colour difference between three product groups:
1. Products with low-sugars levels (P1-P7, Samples 19-25)
2. Products with medium to high sugars levels (P8-P12, Samples 26-30)
3. Products with low-sugars levels and roasted ingredients (Samples 1-8)

It was evidenced that products with low-sugar levels (P1-P7, Samples 19-25) have lower a* value, compared to products with medium to high sugar amount (P8-P12. Samples 26-30). The addition of roasted ingredients to low sugar product (Samples 1-8) shifts the colour to the colour space of products with medium to high sugar level and thus solves the problem of pale colour without compromising on nutritional superiority (keeping sugar level low).

It must be noted that some native (non-roasted) cereal grains and edible seeds have naturally the colour that can also increase the a* value in the product depending on their dosage. For example, products P5 (based on buckwheat) and product P6 (multicreedal recipe with 8 grains: oat, barley, triticale, spelt, wheat, rice, maize, rye) revealed significantly higher a* values than other products from low-sugars segment. These grains can potentially solve the problem of pale colour, nevertheless, they cannot improve the flavour if not roasted. This was demonstrated through sensory evaluation as well as through quantification of aroma markers as discussed above and shown in Table 6.

### Example 7: High-Sugar Products without Roasted Ingredients

This example demonstrates the situation in products with high sugar. Five products P8-P12 (Table 6, Case 6, Samples 26-30) were collected in a retail shop or prepared in a pilot plant or a factory trial. The total amount of sugars in these products ranged from 10 to 22 g/100 g (amounts provided without naturally occurring lactose from milk powder present in complete products). In general, these products are characterized by appealing brownish colour of powder and pap and strong sweet taste with cookie/biscuity notes. Regarding aroma markers, these products contain high levels of Strecker aldehydes and no or very low levels of pyrazines and HDMF. Only product P9 (Sample 27) revealed elevated amount of HDMF (14175 ppb) that was explained by flavouring present in this product and confirmed by tasting of strong caramel flavour. None of the products from this segment meets all criteria for aroma markers specific to the product of the invention. This example thus shows that aroma signature achieved through our invention is different from the signature achieved through traditional technology established for production of processed cereal-based product.

1. A low sugar food composition with organoleptic properties for infants and young children comprising a plant-based roasted ingredient, wherein the total sugars in the composition is less than 5 g/100 g; wherein said composition has a* colour space parameter comprising a a*value above 0; and
wherein the roasted ingredient is obtainable by roasting to an extent that when said roasted ingredient is added to the food composition, the said food composition comprises sum of pyrazines containing 2-ethyl-6-methylpyrazine, 2-ethyl-5-methylpyrazine, 2,3,5-trimethylpyrazine, 2-ethyl-3-methylpyrazine, 2-ethyl-3,6-dimethylpyrazine and 2-ethyl-3,5-dimethylpyrazine in amount greater than 20 parts per billion (ppb).

2. The composition of claim 1 wherein total amount of sugars refers to mono-saccharides, except naturally occurring lactose from dairy ingredients.

3. The composition of claim 1 wherein the amount of furan is below 50 ppb.

4. The composition of claim 1 wherein the amount of acrylamide is below 60 ppb.

5. The composition of claim 1 wherein the total amount of Strecker aldehydes containing 3-methylbutanal, 2-methylbutanal, methional and phenylacetaldehyde is greater than 150 ppb.

6. The composition of claim 1 wherein the amount of 4-hydroxy-2,5-dimethyl-3 (2H)-furanone (HDMF) is greater than 200 ppb.

7. The composition of claim 1 wherein the composition is a powder.

8. The composition of claim 1, wherein the composition is a pap and wherein the a*value is above 0.5.

9. The composition of claim 1 wherein the composition is standard or complete cereal-based product for infants and young children.

10. The composition of claim 1 wherein the total sugar amount is less than 2.5 g/100 g of the final composition.

11. A method of preparing a composition with organoleptic properties comprising a plant-based roasted ingredient, wherein the total sugars in the composition is less than 5 g/100 g comprising:
a. providing a plant-based ingredient;
b. roasting of the said plant-based ingredient to a temperature ranging from 120° C. to 220° C. for time between 1 min to 600 min;
c. grinding of said roasted ingredient to obtain a flour;
d. incorporation of said flour into cereal-based composition at dosage between 1% to 50% w/w; and
e. subjecting to any of following processes comprising roller-drying, extrusion, baking and/or spray-drying to obtain a finished product.

12. A method according to claim 11 wherein the roasting is performed at a temperature ranging from 140° C. to 220° C. for time between 1 min to 600 min.

13. The method of claim 11, wherein the roasting is performed at temperatures of 160 to 220° C. for 5 to 20 minutes.

14. The method of claim 11 wherein the amount of incorporation of roasted ingredient ranges from 2.5 to 10% w/w.

15. The method of claim 11 wherein between steps a and b comprises a step of measuring the L*a* b*colour space parameters of the native plant-based ingredient and performing step b of roasting till the extent such that at least one of the L*a* b*colour space parameters is changed by at least 5% after roasting.

16. The method of claim 11 wherein the roasted plant-based ingredient comprises total amount of pyrazines containing 2-ethyl-6-methylpyrazine, 2-ethyl-5-methylpyrazine, 2,3,5-trimethylpyrazine, 2-ethyl-3-methylpyrazine, 2-ethyl-3,6-dimethylpyrazine and 2-ethyl-3,5-dimethylpyrazine greater than 200 ppb.

17. The method of claim 11 wherein the roasted plant-based ingredient comprises total amount of Strecker aldehydes containing 3-methylbutanal, 2-methylbutanal, methional and phenylacetaldehyde greater than 1500 ppb.

18. The method of claim 11 wherein the roasted plant-based ingredient is adapted until the finished product comprises amount of 4-hydroxy-2,5-dimethyl-3 (2H)-furanone (HDMF) greater than 2000 ppb.

19-20. (canceled)

21. The method of claim 11 wherein the roasted plant-based ingredient is adapted until the finished product comprises total amount of Strecker aldehydes containing 3-methylbutanal, 2-methylbutanal, methional and phenylacetaldehyde greater than 150 ppb.

22-23. (canceled)

24. The method according to claim 11 wherein incorporation of flour into cereal-based composition according to step d) of the method is performed by dry-mixing.

25-26. (canceled)
